(19) United States
(12) Patent Application Publication
(10) Pub. No.: US 2024/0147497 A1
(43) Pub. Date: May 2, 2024

(54) RLM PROCEDURES FOR SIDELINK

(71) Applicant: TELEFONAKTIEBOLAGET LM ERICSSON (PUBL), STOCKHOLM (SE)

(72) Inventors: Shehzad Ali Ashraf, AACHEN (DE); Ricardo Blasco Serrano, ESPOO (FI)

(21) Appl. No.: 17/769,284

(22) PCT Filed: Oct. 13, 2020
(86) PCT No.: PCT/IB2020/059602

§ 371 Date: Apr. 14, 2022

Related U.S. Application Data
(60) Provisional application No. 62/914,893, filed on Oct. 14, 2019.

(51) Int. Cl. H04W 72/25; H04L 1/00; H04L 5/00

(52) U.S. Cl. CPC H04W 72/25; H04L 1/0061; H04L 5/0048

(57) ABSTRACT

Systems and methods for sidelink Radio Link Monitoring (RLM) are disclosed. In one embodiment, a method performed by a first wireless communication device for RLM for a sidelink between the first wireless communication device and a second wireless communication device comprises transmitting a first part of sidelink control information (SCI) to the second wireless communication device, the first part of the SCI comprising information regarding one or more reference signals that are present on the sidelink for RLM measurements. In this manner, RLM is enabled without the need of (pre-)configured periodic signaling such as Channel State Information Reference Signal (CSI-RS) or Synchronization Signal Block (SSB).

### RELATED APPLICATIONS

This application claims the benefit of provisional patent application Ser. No. 62/914,893, filed Oct. 14, 2019, the disclosure of which is hereby incorporated herein by reference in its entirety.

### TECHNICAL FIELD

The present disclosure relates to a wireless communications system and, in particular, to Radio Link Monitoring (RLM) procedures for a sidelink in a wireless communications system.

### BACKGROUND

During Release 14 and Release 15, the Third Generation Partnership Project (3GPP) Long Term Evolution (LTE) standard has been extended with support of Device-to-Device (D2D) (specified as “sidelink”) features targeting vehicular communications, collectively referred to as Vehicle to Anything (V2X) communications. Besides Vehicle-to-Vehicle (V2V) communication, V2X includes V2P (Vehicle-to-Pedestrian or pedestrian-to-vehicle), V2I (Vehicle-to-Infrastructure), and V2N (Vehicle-to-Network) as shown in FIG. 1, which illustrates V2X scenarios enabled by the cellular uplink, downlink, and sidelink in a 3GPP NR system.

The on-going Fifth Generation (5G) V2X standardization efforts in Release 16 aim at enhancing the 3GPP New Radio (NR) system to meet stringent Quality of Service (QoS) requirements, e.g. in terms of latency and reliability, of advanced V2X services that are beyond the capabilities of the V2X safety services supported by LTE V2X Release 14 and Release 15. Therefore, the NR sidelink (SL) design includes new features, including physical layer unicast, power control, Hybrid Automatic Repeat Request (HARQ), and QoS management. A key technical feature of the NR sidelink for V2X is the capability to support physical-layer unicast and groupcast, which is also called multicast, as compared with the broadcast-only LTE sidelink.

There are two operation modes for the NR sidelink One operation mode is the network-based Mode 1. Network-based Mode 1 is a mode of operation in which the network selects the resources and other transmit parameters assigned to sidelink User Equipments (UEs) by means of scheduling grants. In some cases, the network may control every single transmission parameter. In other cases, the network may select the resources used for transmission but may give the transmitter the freedom to select some of the transmission parameters, possibly with some restrictions. The other operation mode is the autonomous Mode 2. Autonomous Mode 2 is a mode of operation in which the UEs autonomously select the resources and other transmit parameters. In this mode, there may be no intervention by the network (e.g., out of coverage, unlicensed carriers without a network deployment) or very minimal intervention by the network (e.g., configuration of pools of resources, etc.). Mode 2 resource allocation is based on resource reservation and sensing of these reservations by UEs to predict future resource utilization.

In NR SL, Sidelink Control Information (SCI) is divided into two parts, a first SCI (SCI1) and a second SCI (SCI2). SCI1 is transmitted over the Physical Sidelink Control Channel (PSCCH), which has a dedicated set of Demodulation Reference Signals (DMRS), while SCI2 shares DMRS with the data channel, i.e., the Physical Sidelink Shared Channel (PSSCH). In order to demodulate and decode the data channel, both SCI1 and SCI2 need to be decoded first.

This is particularly useful for sidelink Mode 2 where resource allocation is performed autonomously by a UE after channel sensing. Sensing includes decoding of SCI1 from other UEs carrying resource allocation related information (e.g. occupied frequency and time resources and priority level) and, based on the decoded information, a UE can decide the available resource and perform resource selection. Since all UEs operating in Mode 2 rely on decoding of SCI1, the coverage of SCI1 should be quite high as compared to actual data transmissions. However, in order to decode the actual data, a receiving UE also needs to decode SCI2 which contains other information related to decoding e.g. modulation and coding scheme, HARQ process identity (ID), Redundancy Version (RV), etc.

In the NR Uu interface, the Block Error Rate (BLER) is used as a metric for link monitoring. Particularly, if the BLER using the hypothetical Physical Downlink Control Channel (PDCCH) is lower/higher than the corresponding threshold, the link is determined to be in-sync/out-of-sync. The following text related to Radio Link Monitoring (RLM) in the NR Uu interface is obtained from 3GPP Technical Specification (TS) 38.133 V16.1.0.

TABLE 8
TS 38.133:
The threshold Qₒᵤₜ is defined as the level at which the downlink radio link cannot be reliably
received and shall correspond to the out-of-sync block error rate (BLERₒᵤₜ) as defined in Table
8.1.1-1. For SSB based radio link monitoring, Qₒᵤₜ_{_{—}}_{SSB} is derived based on the hypothetical
PDCCH transmission parameters listed in Table 8.1.2.1-1. For CSI-RS based radio link
monitoring, Qₒᵤₜ_{_{—}}_{CSI-RS} is derived based on the hypothetical PDCCH transmission parameters
listed in Table 8.1.3.1-1.
. . .
The out-of-sync block error rate (BLERₒᵤₜ) and in-sync block error rate (BLERᵢₙ) are determined
from the network configuration via parameter rlmInSyncOutOfSyncThreshold signalled by
higher layers. When UE is not configured with RLM-IS-OOS-thresholdConfig from the network,
UE determines out-of-sync and in-sync block error rates from Configuration #0 in Table 8.1.1-1
as default. . . .

Table 8.1.1-1: Out-of-sync and in-sync block error rates

| Configuration | BLERₒᵤₜ | BLERᵢₙ |
|---|---|---|
| 0 | 10% | 2% |

There currently exist certain challenge(s). The current in-sync (IS)/out-of-sync (OOS) determination procedure supported in NR Uu for RLM uses specific downlink signals such as Synchronization Signal Block (SSB) and/or Channel State Information Reference Signal (CSI-RS) for measurements, which are periodic in nature and are semi-statically configured by the network. However, in sidelink, although (pre-) configured periodically, the SSB signals are transmitted by all the UEs due to the distributed nature of operation. This lack of central coordination makes it difficult to recognize the specific SSB signals between a pair of UEs for which RLM needs to be performed. On the other hand, there is no (pre-)configured periodic reference signals such as CSI-RS which can be used for the purpose of RLM in the sidelink.

### SUMMARY

Systems and methods for sidelink Radio Link Monitoring (RLM) are disclosed. In one embodiment, a method performed by a first wireless communication device for RLM for a sidelink between the first wireless communication device and a second wireless communication device comprises transmitting a first part of sidelink control information (SCI) to the second wireless communication device, the first part of the SCI comprising information regarding one or more reference signals that are present on the sidelink for RLM measurements. In this manner, RLM is enabled without the need of (pre-)configured periodic signaling such as Channel State Information Reference Signal (CSI-RS) or Synchronization Signal Block (SSB).

In one embodiment, the method further comprises transmitting a second part of the SCI to the second wireless communication device, transmitting data on a physical sidelink shared channel, and transmitting the one or more reference signals on the sidelink. The second part of the SCI comprises information related to decoding the data transmitted on the physical sidelink shared channel. In one embodiment, the information related to decoding the data transmitted on the physical sidelink shared channel comprises: (a) information about a modulation a coding scheme used for the data transmitted on the physical sidelink shared channel, (b) a hybrid automatic repeat request (HARQ) identity of a HARQ process associated to the data transmitted on the physical sidelink shared channel, (c) a redundancy version of the data transmitted on the physical sidelink shared channel, or (d) a combination of any two or more of (a)-(c). In one embodiment, the second part of the SCI shares demodulation reference signals with a physical data channel on the sidelink. In one embodiment, the method further comprises receiving information that indicates a radio link failure from the second wireless communication device and performing a radio link failure recovery procedure in response to receiving the information that indicates a radio link failure from the second wireless communication device. In one embodiment, performing the radio link recovery procedure comprises reconfiguring one or more transmission parameters for a second part of the SCI.

In one embodiment, the first part of the SCI is transmitted on a physical sidelink control channel that has a dedicated set of demodulation reference signals.

In one embodiment, the first part of the SCI further comprises resource allocation related information.

In one embodiment, the information regarding the one or more reference signals that are present on the sidelink for RLM measurements comprises information needed by the second wireless communication device to receive the one or more reference signals on the sidelink.

In one embodiment, the information regarding the one or more reference signals that are present on the sidelink for RLM measurements comprises information that implicitly or explicitly indicates a time, frequency, or code resource allocation for the one or more reference signals. In one embodiment, the information that implicitly or explicitly indicates a time, frequency, or code resource allocation for the one or more reference signals comprises one or more bit fields that provide the time, frequency, and/or code resource allocation for the one or more reference signals, a single bit that indicates the presence of the one or more reference signals on predefined or preconfigured time, frequency, and/or code resources, or a cyclic redundancy check (CRC) that implicitly indicates the time, frequency, and/or code resources used for the one or more reference signals.

In one embodiment, the one or more reference signals comprise one or more demodulation reference signals, two or more demodulation reference signals for two or more different physical channels, one or more channel state information reference signals, or one or more phase tracking reference signals.

In one embodiment, the one or more reference signals comprise two or more different types of reference signals.

Corresponding embodiments of a first wireless communication device for RLM for a sidelink between the first wireless communication device and a second wireless communication device are also disclosed. In one embodiment, the first wireless communication device is adapted to transmit a first part of SCI to the second wireless communication device, the first part of the SCI comprising information regarding one or more reference signals that are present on the sidelink for RLM measurements.

In one embodiment, a first wireless communication device for RLM for a sidelink between the first wireless communication device and a second wireless communication device comprises one or more transmitters, one or more receivers, and processing circuitry associated with the one or more transmitters and the one or more receivers. The processing circuitry is configured to cause the first wireless communication device to transmit a first part of SCI to the second wireless communication device, the first part of the SCI comprising information regarding one or more reference signals that are present on the sidelink for RLM measurements.

Embodiments of a method performed by a second wireless communication device for RLM for a sidelink between a first wireless communication device and the second wireless communication device are also disclosed. In one embodiment, the method comprises receiving a first part of SCI from the first wireless communication device, the first part of the SCI comprising information regarding one or more reference signals that are present on the sidelink for RLM measurements. The method further comprises determining a presence of the one or more reference signals on the sidelink based on the first part of the SCI, performing one or more RLM measurements on the one or more reference signals; and determining a RLM metric based on the one or more RLM measurements.

In one embodiment, the first part of the SCI is transmitted on a physical sidelink control channel that has a dedicated set of demodulation reference signals. In one embodiment, the first part of the SCI further comprises resource allocation related information.

In one embodiment, a second part of the SCI comprises information related to decoding data transmitted from the first wireless communication device to the second wireless communication device on a physical sidelink shared channel. In one embodiment, the information related to decoding the data transmitted on the physical sidelink shared channel comprises: (a) information about a modulation a coding scheme used for the data transmitted on the physical sidelink shared channel, (b) a HARQ identity of a HARQ process associated to the data transmitted on the physical sidelink shared channel, (c) a redundancy version of the data transmitted on the physical sidelink shared channel, or (d) a combination of any two or more of (a)-(c). In one embodiment, the second part of the SCI shares demodulation reference signals with a physical data channel on the sidelink.

In one embodiment, determining the RLM metric based on the one or more RLM measurements comprises determining the RLM metric based on the one or more RLM measurements, one or more hypothetical transmission parameters for a second part of the SCI, and one or more criteria. In one embodiment, the one or more criteria comprises one or more block error rate (BLER) thresholds. Further, determining the RLM metric based on the one or more RLM measurements, the one or more hypothetical transmission parameters for a second part of the SCI, and the one or more criteria comprises computing a BLER value for the second part of the SCI based on the one or more RLM measurements and the one or more hypothetical transmission parameters for the second part of the SCI and comparing the BLER value to the one or more BLER thresholds. In one embodiment, the RLM metric is in-sync or out-of-sync. In one embodiment, the one or more criteria is a function of: a priority of one or more services with different quality of service requirements involved with the sidelink between the first and second wireless communication devices, a function of a precoder used for transmission of the one or more reference signals, or a function of a number of layers used for transmission of the second part of the SCI.

In one embodiment, the information regarding the one or more reference signals that are present on the sidelink for RLM measurements comprises information needed by the second wireless communication device to receive the one or more reference signals on the sidelink.

In one embodiment, the information regarding the one or more reference signals that are present on the sidelink for RLM measurements comprises information that implicitly or explicitly indicates a time, frequency, or code resource allocation for the one or more reference signals. In one embodiment, the information that implicitly or explicitly indicates a time, frequency, or code resource allocation for the one or more reference signals comprises: one or more bit fields that provide the time, frequency, and/or code resource allocation for the one or more reference signals, a single bit that indicates the presence of the one or more reference signals on predefined or preconfigured time, frequency, and/or code resources, or a CRC that implicitly indicates the time, frequency, and/or code resources used for the one or more reference signals.

In one embodiment, the one or more reference signals comprise one or more demodulation reference signals, two or more demodulation reference signals for two or more different physical channels, one or more channel state information reference signals, or one or more phase tracking reference signals.

In one embodiment, the one or more reference signals comprise two or more different types of reference signals.

In one embodiment, the method further comprises sending information that indicates a radio link failure to the first wireless communication device.

In one embodiment, the method further comprises declaring a radio link failure based on the determined RLM metric. In one embodiment, the determined RLM metric is out-of-sync. In one embodiment, the method further comprises, upon declaring the radio link failure, performing one or more actions comprising one or more of the following: signaling information that indicates the radio link failure to another node, determining one or more hypothetical transmission parameters for the second part of the SCI to be used for future determination of a future RLM metric, determining a parameter to be used for transmission of the second part of the SCI or a physical sidelink control channel, or transmitting a control message that declares the radio link failure using a parameter.

In one embodiment, the second part of the SCI shares a demodulation reference signal (DMRS) with a physical data channel on the sidelink.

In one embodiment, the first part of the SCI is transmitted on a physical sideline control channel (PSCCH) that has a dedicated set of DMRS.

Corresponding embodiments of a second wireless communication device for RLM for a sidelink between a first wireless communication device and the second wireless communication device are also disclosed. In one embodiment, the second wireless communication device is adapted to receive a first part of SCI from the first wireless communication device, the first part of the SCI comprising information regarding one or more reference signals that are present on the sidelink for RLM measurements. The second wireless communication device is further adapted to determine a presence of the one or more reference signals on the sidelink based on the first part of the SCI, perform one or more radio link monitoring, RLM, measurements on the one or more reference signals, and determine a RLM metric based on the one or more RLM measurements.

In one embodiment, a second wireless communication device for RLM for a sidelink between a first wireless communication device and the second wireless communication device comprises one or more transmitters, one or more receivers, and processing circuitry associated with the one or more transmitters and the one or more receivers. The processing circuitry is configured to cause the second wireless communication device to receive a first part of SCI from the first wireless communication device, the first part of the SCI comprising information regarding one or more reference signals that are present on the sidelink for RLM measurements. The processing circuitry is further configured to cause the second wireless communication device to determine a presence of the one or more reference signals on the sidelink based on the first part of the SCI, perform one or more radio link monitoring, RLM, measurements on the one or more reference signals, and determine a RLM metric based on the one or more RLM measurements.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates Vehicle-to-Anything (V2X) scenarios enabled by the cellular uplink, downlink, and sidelink in a Third Generation Partnership Project (3GPP) New Radio (NR) system;

FIG. 2 illustrates one example of a cellular communications system in which embodiments of the present disclosure may be implemented;

FIG. 3 is a flow chart that illustrates the operation of a first radio device in accordance with one embodiment of the present disclosure;

FIG. 4 is a flow chart that illustrates the operation of a second radio device in accordance with one embodiment of the present disclosure;

FIGS. 5, 6, and 7 are schematic block diagrams of example embodiments of a radio access node; and

FIGS. 8 and 9 are schematic block diagrams of example embodiments of a wireless communication device.

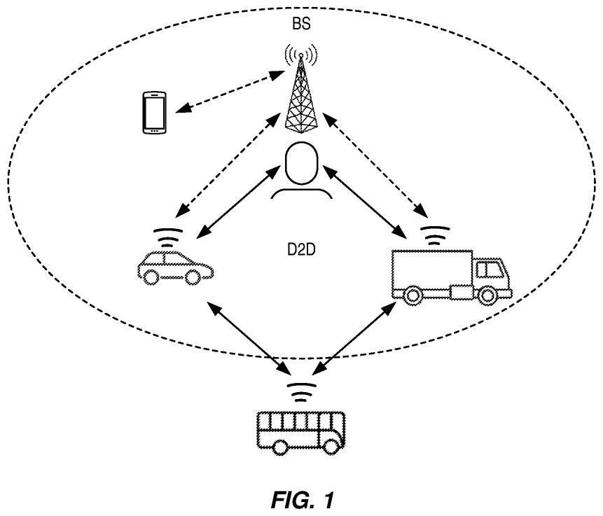

These figures may be better understood by reference to the following detailed description.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

As discussed above, the existing in-sync (IS)/out-of-sync (OOS) procedure of Radio link monitoring (RLM) in the NR Uu interface cannot be reused for sidelink operation due to following reasons:
(1) lack of procedure to differentiate between Synchronization Signal Block (SSB) transmissions by a pair of UEs due to distributed mode of operation where all UEs transmit SSB in Single Frequency Network (SFN) manner, and
(2) lack of periodic reference signals which are (pre-)configured that can be used for RLM measurements.

Certain aspects of the present disclosure and their embodiments may provide solutions to the aforementioned or other challenges. In some embodiments, IS and/or OOS is determined by a radio device (e.g., a wireless communication device or a UE) based on reference signals that are dynamically indicated by another radio device (e.g., another wireless communication device or another UE) using a first part of sidelink control signaling (e.g., Sidelink Control Information (SCI) part 1 (SCI1)). In some embodiments, after performing RLM measurements on the received reference signals, the IS/OOS is determined using a certain threshold (e.g. Block Error Rate (BLER) threshold) and transmission parameters (e.g. number of symbols, bandwidth, etc.) used for a second part of sidelink control signaling (e.g., SCI part 2 (SCI2)).

In some embodiments, a radio device (e.g., a wireless communication device or a UE) dynamically indicates in a first part of SCI to another radio device (e.g., another wireless communication device or another UE) in a device pair the reference signal used for RLM measurements. Based on these RLM measurements and specific criteria (based on priority etc.), the radio device determines IS/OOS using the hypothetical transmission parameters of a second part of SCI (e.g., SCI2).

Certain embodiments may provide one or more of the following technical advantage(s). Embodiments of the present disclosure may allow IS/OOS as a metric to be used for RLM without the need of (pre-)configured periodic signaling such as Channel State Information Reference Signal (CSI-RS) or SSB.

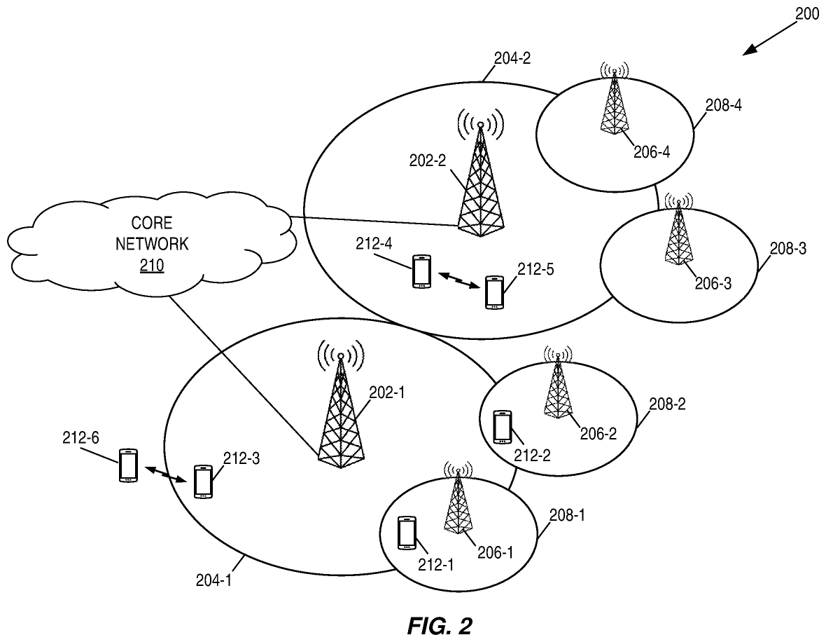

FIG. 2 illustrates one example of a cellular communications system 200 in which embodiments of the present disclosure may be implemented. In the embodiments described herein, the cellular communications system 200 is a 5G system (5GS) including a NR RAN (also referred to as a Next Generation (NG) RAN (i.e., a NG-RAN)). In this example, the RAN includes base stations 202-1 and 202-2, which in 5G NR are referred to as gNBs or ng-eNBs in the case of LTE RAN nodes connected to 5GC, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5G core (5GC). The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212.

Note that embodiments described herein relate to sidelink communication between wireless communication devices 112. For example, in the example of FIG. 2, wireless communication devices 212-4 and 212-5 communicate via a sidelink, and the wireless communication device 212-3 has a sidelink with another wireless device 212-6 that is out of network coverage.

In the following description, the wireless communication devices 212 are oftentimes referred to as “radio devices” or “UEs,” but the present disclosure is not limited thereto.

Now, a description of some example embodiments of the present disclosure will be provided. For the example embodiments described herein, it is assumed that the SCI includes (and in some embodiments consists of) two parts, which are referred here as ‘the first part of SCI’ or ‘SCI1’ and ‘the second part of SCI’ or ‘SCI2’. As described above in relation to Physical Sidelink Control Channel (PSCCH) design, the first part of SCI, among other things, mainly contains information related to resource allocation for sensing based resource allocation (aka. Mode 2 in NR SL) whereas the second part of SCI contains all the remaining information which is necessary for the receiver to know before the actual decoding of data received over Physical Sidelink Shared Channel (PSSCH). On the other hand, for sensing based resource allocation, the first part of SCI should have high coverage and reliability as compared to the second part of SCI and actual data transmissions. This is due to the fact that the first part of SCI needs to be decoded by all the neighboring UEs in order to do sensing based resource allocation for their own transmissions. Whereas, the coverage and reliability of the second part of SCI may not be very high as compared to data transmissions because this information is only needed by the receiver devices to successfully decode the data transmission and the other UEs which are not interested in receiving the data may not have to receive it. Still it is envisioned that the reliability of the second part of SCI needs to be higher than data transmissions in some cases since data can support soft combining of HARQ retransmissions, which cannot be done for the second part of SCI. Furthermore, if the receiver radio device is unable to decode the SCI, the receiver device will declare radio link failure so that steps can be taken by the network to recover the radio link.

Based on the above description, in sidelink, RLM can be performed on either the first part of SCI or the second part of SCI. Here, performing ‘RLM on a SCI’ means that the RLM uses the transmissions parameters (e.g., resource allocations, modulation and code-rates, etc.) used for the transmission of SCI.

Furthermore, in sidelink, performing RLM on the first part of SCI would require a UE to have (pre-)configured reference signals (RS) used for RLM measurements. However, so far for sidelink, such (pre-)configured RLM RS are not supported. Therefore, a new mechanism is required so that RLM can be performed for sidelink Example embodiments of such a mechanism are described below in detail.

According to one embodiment, the RLM measurements are performed on the reference signals which are scheduled dynamically using the first part of SCI, and an RLM metric (e.g. in-sync and/or out-of-sync) is determined by comparing a BLER obtained using the hypothetical transmission parameters of the second part of SCI with the corresponding (pre-) configured BLER thresholds. Based on this procedure, a first radio device (e.g., a first wireless communication device or a first UE) transmits the first part of SCI. Among other information, the first part of the SCI also includes information that indicates information necessary to receive the reference signals used for RLM measurements, and the second part of SCI includes remaining information necessary to decode data by a second radio device (e.g., a second wireless communication device or a second UE). After receiving the first part of SCI, the second radio device knows about the presence of reference signals (or the information necessary to receive the reference signals such as time/frequency/code sequence etc.), performs RLM measurement(s) (e.g. RSRP or RSSI) and uses the RLM measurement(s) to determine in-sync (IS) or out-of-sync (OOS) for the radio link between the two radio devices. Furthermore, IS/OOS is determined based on the (pre-)configured criteria to determine whether second radio device is able to decode the second part of SCI or not. Here, the criteria include the (pre-)configured BLER thresholds to be used for comparing the BLER obtained using the hypothetical transmission parameters used for the second part of SCI.

According to a sub-embodiment, the reference signals (RS) used for RLM measurements are demodulation reference signals (DMRS) or channel state information RS (CSI-RS) or any other RS such as phase tracking RS (PTRS) etc. In one case, RLM measurements can be performed on the combination of two or more different RSs and the use of one or more RSs for RLM measurements can be (pre-) configured. In another case, the RS signals used for RLM measurements are DMRS for multiple physical channels (e.g., PSCCH and PSSCH).

According to another sub-embodiment, the first part of SCI indicates the RS used for RLM measurements either implicitly or explicitly. For instance, it can be a separate field indicating the time and/or frequency and/or code resource containing the RS or just a 1-bit field indicating the presence of RS in a pre-defined time, frequency, and code resource. In another example, the RS indication is done in an implicit manner such as the function of cyclic redundancy check (CRC) i.e. CRC determines the RS used for RLM measurements.

According to another sub-embodiment, different criteria to declare IS or OOS are used for different services with different QoS requirements. For instance, a radio device pair involved in high priority service can use lower BLER threshold (e.g. 7%) to indicate OOS and lower BLER threshold (e.g. 1%) to indicate IS; whereas a radio device pair involved in low priority service can use higher BLER threshold (e.g. 10%) to indicate OOS and higher BLER threshold (e.g. 4%) to indicate IS. In one case, a radio device pair can have multiple transmission sessions with different services and, IS and/or OOS declaration by a radio device is independent for each session depending on the corresponding QoS requirements. In order to support this, QoS related information (such as priority etc.) is indicated to the receiver radio device(s) using the first part of SCI, either explicitly as a separate field (e.g. priority field) or implicitly from other information (e.g. layer 1 IDs). In another example, a radio device pair can have multiple transmissions sessions with different services, and IS and/or OOS criteria used for each session is different based on QoS requirements; however, a radio device declares IS/OOS as a joint function of different sessions. For example, if high-priority session is OOS, a radio device declares OOS for sessions with lower priorities as well.

According to another sub-embodiment, different IS or OOS criteria are defined depending on the number of layers used for the transmission of the second part of SCI. For instance, if the second part of SCI is transmitted using 2-layers, the criteria used to determine IS and OOS is different as compared to the criteria used when second part of SCI is transmitted using single layer.

According to another sub-embodiment, different IS or OOS criteria are defined depending on the precoder used for the transmission of RS used for RLM measurements. This is because based on the used precoder, RLM measurements may reflect different channel conditions (including precoding affect) which might be different from the actual channel conditions. To support this case, precoder information needs to be indicated to the receiver radio device which can be done either semi-statically by RRC signaling or dynamically by the first part of SCI.

According to another sub-embodiment, a table is (pre-)configured which defines the transmission parameters used to obtain hypothetical BLER and the corresponding criteria (e.g. BLER thresholds) to declare IS and/or OOS. In one example, one configuration of TX parameters corresponds to one criterion and, in another example, one configuration of TX parameters corresponds to multiple criteria depending on QoS parameters, precoder, and number of layers etc. In some cases, the index to this table is signaled by a radio device to another radio device using first part of SCI. In other cases, if the index to the table is not signaled, only one configuration of TX parameters is used which can be pre-defined. For example, the most conservative format such as the one using lowest code-rate and modulation etc.

According to another sub-embodiment (suitable for bi-directional communications), in response to determining IS/OOS, the radio device adjusts parameter(s) for its own transmissions. For example, in response to determining OOS the radio device may select a more conservative format (e.g., with lower coding rate, lower order modulation, etc.) for transmitting the second part of SCI or for transmitting PSSCH. Similarly, the radio device may select a more aggressive format (e.g., with higher coding rate, higher order modulation, etc.) in response to determining IS. In some cases, the new format may be used for transmitting an RLF declaration to the peer radio device.

The following describes the procedures/methods from first radio device transmitting the control, data, and RS and second radio device receiving the information and determining IS/OOS.

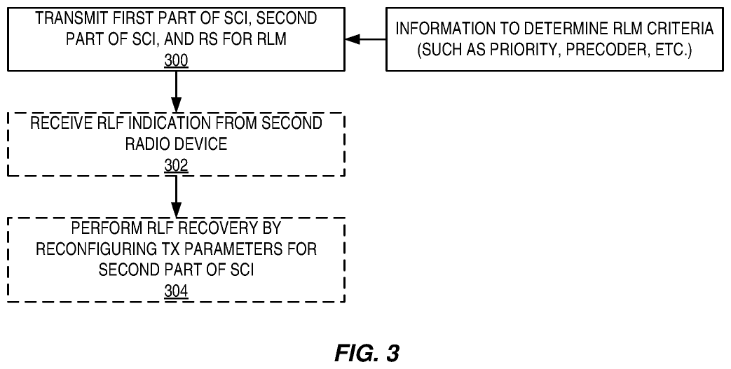

FIG. 3 is a flow chart that illustrates the operation of a first radio device in accordance with one embodiment of the present disclosure. Optional steps are represented by dashed lines/boxes. The first radio device is a first radio device in a pair of radio devices for sidelink communication. The first radio device may be a first wireless communication device 212 (e.g., a first UE). The steps of the process of FIG. 3 are as follows.

Step 300: The first radio device transmits the first part of SCI, the second part of SCI, actual data, and the related RS for RLM. Note that all of the details above regarding the different embodiments and sub-embodiments of the present disclosure that relate to the transmission of the first part of the SCI, the second part of the SCI, the actual data, and the related RS for RLM are applicable here. For example, in some embodiments, the first part of SCI is SCI1, which is transmitted over the PSCCH which has a dedicated set of DMRS. In some embodiments, the second part of SCI is SCI2 shares DMRS with the data channel (i.e., PSCCH). As also discussed above, in some embodiments, the RS for RLM are, e.g., DMRS, CSI-RS, or any other type of RS (e.g., PTRS), or any desired combination of two or more different types of RSs.

The first radio device indicates dynamically to the second radio device the presence of RS used for RLM measurements (or the information necessary to receive RS for RLM measurements) using the first part of SCI. For example, as discussed above, in some embodiments, the RS for RLM are dynamically scheduled using the first part of the SCI. For example, as discussed above, the RS for RLM may be dynamically scheduled by an implicit or explicit indication of time, frequency, and/or code resource in the first part of the SCI. All of the details described above regarding this implicit or explicit indication are equally applicable here.

In some embodiments, the first radio device indicates, dynamically in the first part of SCI, the used number of layers (i.e. layer mapping information) for the second part of SCI. In some embodiments, if no information is signaled, it is assumed that the same number of layers as data transmission is used for the second part of SCI.

Optionally, in some embodiments, the first radio device indicates dynamically, in the first part of SCI (or semi-statically in higher layer signaling such as, e.g., RRC signaling), the used precoder for the transmission of RS used for RLM measurements.

Step 302 (Optional): The first radio device may receive an RLF indication from the second radio device.

Step 304 (Optional): If the first radio device receives an RLF indication (e.g., information about an RLF) from the second radio device, the first radio device starts a radio link failure (RLF) recovery procedure. Here, RLF recovery procedure may include adjusting the transmission parameters of the second part of SCI, as discussed above. For instance, allocating more time and frequency resources for the transmission of the second part of SCI so that robust transmissions can be achieved using lower code-rates. Then, the hypothetical transmissions parameters used for obtaining BLER will be different.

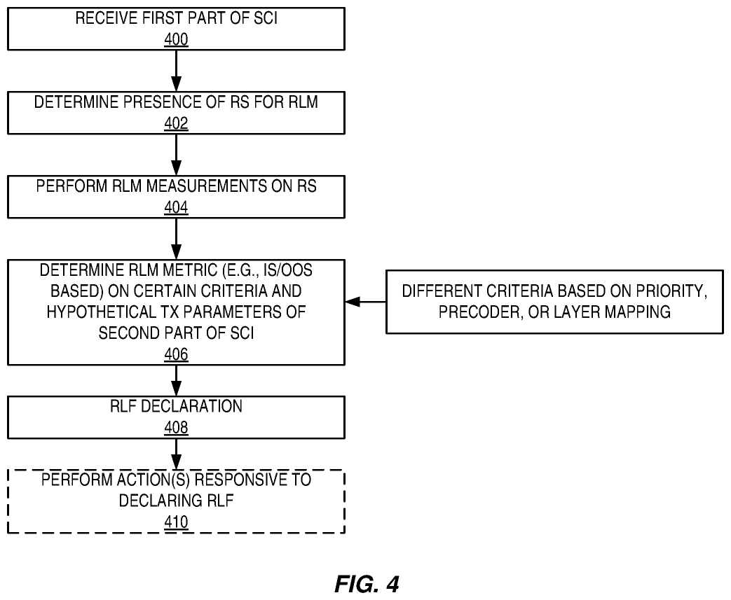

FIG. 4 is a flow chart that illustrates the operation of a second radio device in accordance with one embodiment of the present disclosure. Optional steps are represented by dashed lines/boxes. The second radio device is a second radio device in a pair of radio devices for sidelink communication. The second radio device may be a second wireless communication device 212 (e.g., a second UE). The steps of the process of FIG. 4 are as follows.

Step 400: The second radio device receives, from the first radio device, the first part of SCI, the second part of SCI, and the RS to perform RLM measurements. Note that all of the details above regarding the different embodiments and sub-embodiments of the present disclosure that relate to the reception of the first part of the SCI, the second part of the SCI, and the related RS for RLM are applicable here. For example, in some embodiments, the first part of SCI is SCI1, which is transmitted over the PSCCH which has a dedicated set of DMRS. In some embodiments, the second part of SCI is SCI2 shares DMRS with the data channel (i.e., PSCCH). As also discussed above, in some embodiments, the RS for RLM are, e.g., DMRS, CSI-RS, or any other type of RS (e.g., PTRS), or any desired combination of two or more different types of RS s.

Step 402: After successfully decoding the first part of SCI, the second radio device determines the presence of RS used for RLM measurement and/or a parameter necessary to perform a measurement on RS for RLM. For example, as discussed above, in some embodiments, the RS for RLM are dynamically scheduled using the first part of the SCI. For example, as discussed above, the RS for RLM may be dynamically scheduled by an implicit or explicit indication of time, frequency, and/or code resource in the first part of the SCI. All of the details described above regarding this implicit or explicit indication are equally applicable here.

Optionally, as discussed above in some embodiments, the second radio device receives, in the first part of SCI, the used number of layers (i.e. layer mapping information) for the transmission of second part of SCI. In some embodiments, if no information is signaled, it is assumed that the same number of layers as data transmission is used for the second part of SCI.

Optionally, as discussed above in some embodiments, the second radio device receives, in the first part of SCI (or semi-statically in higher layer signaling such as, e.g., RRC signaling), the used precoder for the transmission of RS used for RLM.

Step 404: The second radio device performs RLM measurements (e.g., RSRP, RSSI, or the like) on the RS for RLM.

Step 406: The second radio device determines an RLM metric (e.g., IS or OOS) based on the RLM measurements, certain criteria (e.g., BLER thresholds for IS and OOS), and hypothetical transmission parameters of the second part of the SCI, as described above. For example, using the RLM measurements and the hypothetical transmissions parameters of the second part of the SCI, the second radio node computes a (hypothetical) BLER for the second part of the SCI. The second radio node may then compare this computed BLER for the second part of the SCI to the BLER thresholds for IS and OOS to determine IS or OOS. As described above, in some embodiments, different criteria may be used based on priority, precoder, or layer mapping. Again, all of the details provided above in this regard are equally applicable here.

Optionally, as discussed above in some embodiments, the second radio device determines the certain criteria to be used to determine IS or OOS based on the hypothetical transmission parameter(s) (e.g., the time and frequency resources) of the second part of SCI. In some embodiments, this hypothetical transmission parameter(s) is received in the first part of SCI.

Based on the measurements on RS for RLM and the criteria used to determine IS or OOS, the second radio device determines the RLM metric (i.e., determines IS or OOS).

Step 408: The second radio device determines if RLF should be declared or not based on the RLM metric and, if so, declares a RLF. In some embodiments, if the RLM metric is determined to be OOS, then the second radio device declares a RLF.

Step 410 (optional): In response to declaring a RLF, the second radio device may perform one or more of the following actions:
signaling an indication of an RLF (e.g., to the first radio device) using control signaling (e.g. higher layer signaling such as, e.g., RRC signaling), and/or
determining the hypothetical transmission parameters of a second part of SCI to be used for future determination of IS and/or OOS. These transmission parameters can be signaled by the first radio device using control signaling (e.g. higher layer signaling (e.g., RRC signaling) or the first part of SCI).

In the case of bidirectional communication, in response to declaring a RLF, the second radio device may perform one or more of the following actions:
determining a parameter (e.g., format, modulation, MCS, etc.) to be used for transmission of the second part of SCI or PSCCH; and/or
transmitting a control message declaring RLF using the determined parameter (in the associated second part of SCI or in the corresponding PSSCH).

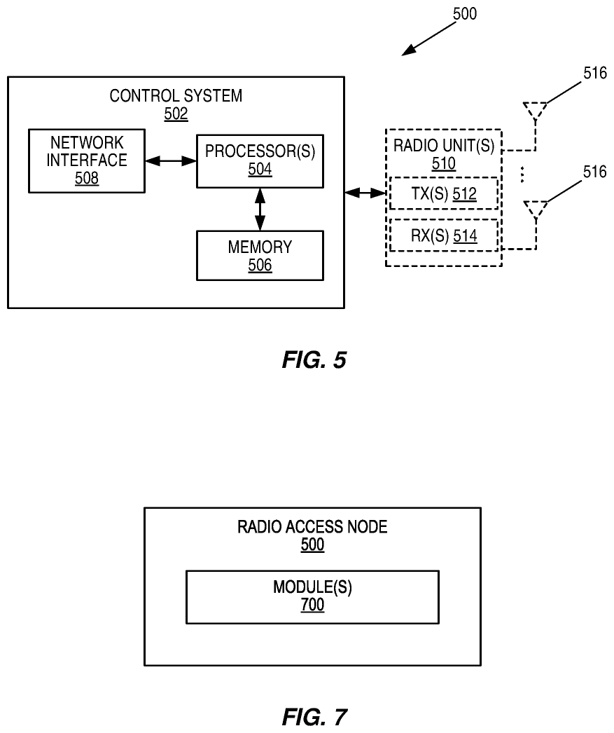

FIG. 5 is a schematic block diagram of a radio access node 500 according to some embodiments of the present disclosure. Optional features are represented by dashed boxes. The radio access node 500 may be, for example, a base station 202 or 206 or a network node that implements all or part of the functionality of the base station 202 or gNB described herein. As illustrated, the radio access node 500 includes a control system 502 that includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. In addition, the radio access node 500 may include one or more radio units 510 that each includes one or more transmitters 512 and one or more receivers 514 coupled to one or more antennas 516. The radio units 510 may be referred to or be part of radio interface circuitry. In some embodiments, the radio unit(s) 510 is external to the control system 502 and connected to the control system 502 via, e.g., a wired connection (e.g., an optical cable). However, in some other embodiments, the radio unit(s) 510 and potentially the antenna(s) 516 are integrated together with the control system 502. The one or more processors 504 operate to provide one or more functions of a radio access node 500 as described herein. In some embodiments, the function(s) are implemented in software that is stored, e.g., in the memory 506 and executed by the one or more processors 504.

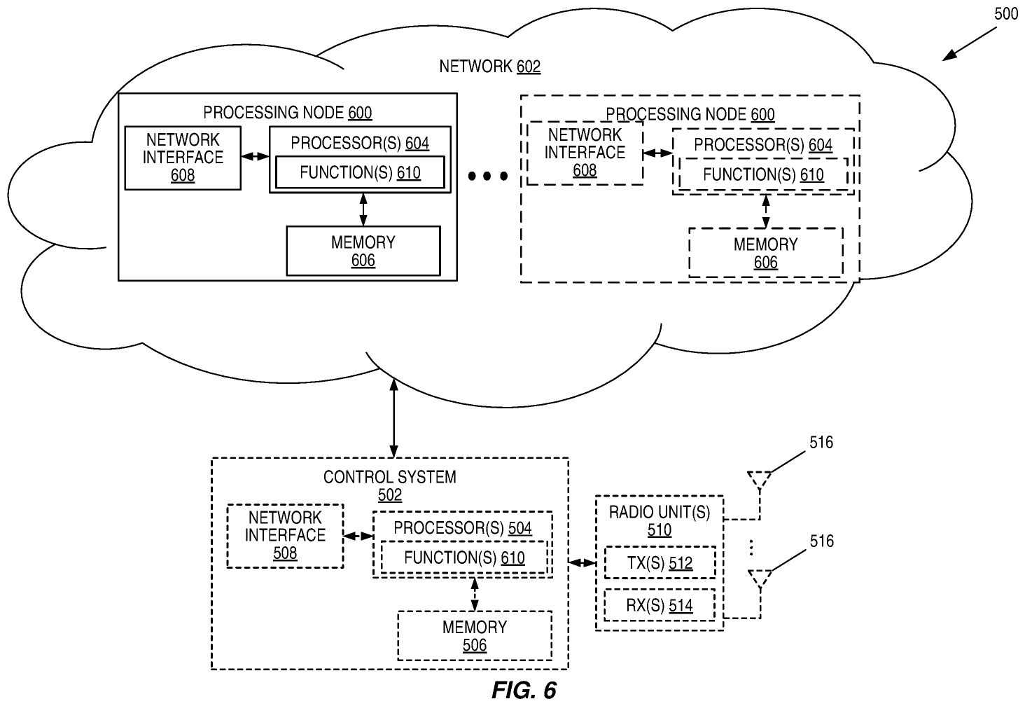

FIG. 6 is a schematic block diagram that illustrates a virtualized embodiment of the radio access node 500 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 500 in which at least a portion of the functionality of the radio access node 500 is implemented as a virtual component(s) (e.g., via a virtual machine(s) executing on a physical processing node(s) in a network(s)). As illustrated, in this example, the radio access node 500 may include the control system 502 and/or the one or more radio units 510, as described above. The control system 502 may be connected to the radio unit(s) 510 via, for example, an optical cable or the like. The radio access node 500 includes one or more processing nodes 600 coupled to or included as part of a network(s) 602. If present, the control system 502 or the radio unit(s) are connected to the processing node(s) 600 via the network 602. Each processing node 600 includes one or more processors 604 (e.g., CPUs, ASICs, FPGAs, and/or the like), memory 606, and a network interface 608.

In this example, functions 610 of the radio access node 500 described herein are implemented at the one or more processing nodes 600 or distributed across the one or more processing nodes 600 and the control system 502 and/or the radio unit(s) 510 in any desired manner. In some particular embodiments, some or all of the functions 610 of the radio access node 500 described herein are implemented as virtual components executed by one or more virtual machines implemented in a virtual environment(s) hosted by the processing node(s) 600. As will be appreciated by one of ordinary skill in the art, additional signaling or communication between the processing node(s) 600 and the control system 502 is used in order to carry out at least some of the desired functions 610. Notably, in some embodiments, the control system 502 may not be included, in which case the radio unit(s) 510 communicate directly with the processing node(s) 600 via an appropriate network interface(s).

In some embodiments, a computer program including instructions which, when executed by at least one processor, causes the at least one processor to carry out the functionality of radio access node 500 or a node (e.g., a processing node 600) implementing one or more of the functions 610 of the radio access node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the radio access node 500 according to some other embodiments of the present disclosure. The radio access node 500 includes one or more modules 700, each of which is implemented in software. The module(s) 700 provide the functionality of the radio access node 500 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

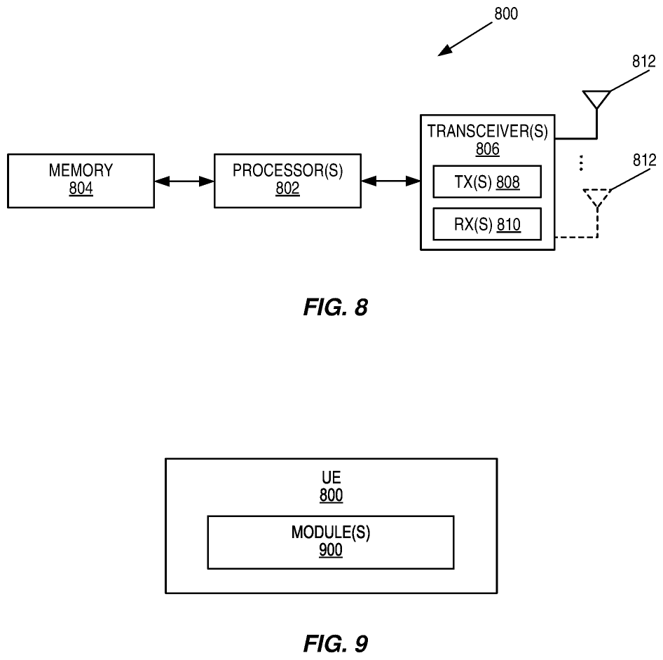

FIG. 8 is a schematic block diagram of a wireless communication device 800, also referred to as user equipment (UE) 800, according to some embodiments of the present disclosure. As illustrated, the wireless communication device 800 includes one or more processors 802 (e.g., CPUs, ASICs, FPGAs, and/or the like), memory 804, and one or more transceivers 806 each including one or more transmitters 808 and one or more receivers 810 coupled to one or more antennas 812. The transceiver(s) 806 includes radio-front end circuitry connected to the antenna(s) 812 that is configured to condition signals communicated between the antenna(s) 812 and the processor(s) 802, as will be appreciated by on of ordinary skill in the art. The processors 802 are also referred to herein as processing circuitry. The transceivers 806 are also referred to herein as radio circuitry. In some embodiments, the functionality of the wireless communication device 800 described above (e.g., the functionality of the first radio device or the second radio device described above) may be fully or partially implemented in software that is, e.g., stored in the memory 804 and executed by the processor(s) 802. The wireless communication device 800 may include additional components not illustrated in FIG. 8 such as, e.g., one or more user interface components (e.g., an input/output interface including a display, buttons, a touch screen, a microphone, a speaker(s), and/or the like and/or any other components for allowing input of information into the wireless communication device 800 and/or allowing output of information from the wireless communication device 800), a power supply (e.g., a battery and associated power circuitry), etc.

In some embodiments, a computer program including instructions which, when executed by at least one processor, causes the at least one processor to carry out the functionality of the wireless communication device 800 according to any of the embodiments described herein (e.g., the functionality of the first radio device or the second radio device described above) is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the wireless communication device 800 according to some other embodiments of the present disclosure. The wireless communication device 800 includes one or more modules 900, each of which is implemented in software. The module(s) 900 provide the functionality of the wireless communication device 800 described herein (e.g., the functionality of the first radio device or the second radio device described above).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows. The present enumerated clauses describe some embodiments of the present disclosure. Combinations of the disclosed embodiments are also within the scope of the present disclosure.

Embodiment 1: A method performed by a first wireless communication device for radio link monitoring for a sidelink between the first wireless communication device and a second wireless communication device, the method comprising: transmitting (300) a first part of sidelink control information, SCI, to the second wireless communication device, the first part of the SCI comprising information regarding one or more reference signals that are present on the sidelink for radio link monitoring measurements.

Embodiment 2: The method of embodiment 1 wherein the information regarding the one or more reference signals that are present on the sidelink for radio link monitoring measurements comprises information needed by the second wireless communication device to receive the one or more reference signals on the sidelink.

Embodiment 3: The method of embodiment 1 wherein the information regarding the one or more reference signals that are present on the sidelink for radio link monitoring measurements comprises information that implicitly or explicitly indicates a time, frequency, or code resource allocation for the one or more reference signals.

Embodiment 4: The method of embodiment 3 wherein the information that implicitly or explicitly indicates a time, frequency, or code resource allocation for the one or more reference signals comprises one or more bit fields that provide the time, frequency, and/or code resource allocation for the one or more reference signals.

Embodiment 5: The method of embodiment 3 wherein the information that implicitly or explicitly indicates a time, frequency, or code resource allocation for the one or more reference signals comprises a single bit that indicates the presence of the one or more reference signals on predefined or preconfigured time, frequency, and/or code resources.

Embodiment 6: The method of embodiment 3 wherein the information that implicitly or explicitly indicates a time, frequency, or code resource allocation for the one or more reference signals comprises a CRC that implicitly indicates the time, frequency, and/or code resources used for the one or more reference signals.

Embodiment 7: The method of any of embodiments 1 to 6 wherein the one or more reference signals comprise one or more DMRS.

Embodiment 8: The method of any of embodiments 1 to 6 wherein the one or more reference signals comprise two or more DMRS for two or more different physical channels.

Embodiment 9: The method of any of embodiments 1 to 8 wherein the one or more reference signals comprise one or more CSI-RS.

Embodiment 10: The method of any of embodiments 1 to 9 wherein the one or more reference signals comprise one or more PTRS.

Embodiment 11: The method of any of embodiments 1 to 10 wherein the one or more reference signals comprise two or more different types of reference signals.

Embodiment 12: The method of any of embodiments 1 to 11 further comprising: receiving (302) information that indicates a radio link failure from the second wireless communication device; and performing (304) a radio link failure recovery procedure in response to receiving (302) the information that indicates a radio link failure from the second wireless communication device.

Embodiment 13: The method of embodiment 12 wherein performing (304) the radio link recovery procedure comprises reconfiguring one or more transmission parameters for a second part of the SCI.

Embodiment 14: The method of embodiment 13 wherein the second part of the SCI shares DMRS with a physical data channel on the sidelink Embodiment 15: The method of any of embodiments 1 to 14 wherein the first part of the SCI is transmitted on a PSCCH that has a dedicated set of DMRS.

Embodiment 16: A method performed by a second wireless communication device for radio link monitoring for a sidelink between a first wireless communication device and the second wireless communication device, the method comprising: receiving (400) a first part of sidelink control information, SCI, from the first wireless communication device, the first part of the SCI comprising information regarding one or more reference signals that are present on the sidelink for radio link monitoring measurements; determining (402) a presence of the one or more reference signals on the sidelink based on the first part of the SCI; performing (404) one or more radio link monitoring, RLM, measurements on the one or more reference signals; and determining (406) a RLM metric based on the one or more RLM measurements.

Embodiment 17: The method of embodiment 16 wherein determining (406) the RLM metric based on the one or more RLM measurements comprises determining (406) the RLM metric based on the one or more RLM measurements, one or more hypothetical transmission parameters for a second part of the SCI, and one or more criteria.

Embodiment 18: The method of embodiment 17 wherein: the one or more criteria comprises one or more BLER thresholds; and determining (406) the RLM metric based on the one or more RLM measurements, the one or more hypothetical transmission parameters for a second part of the SCI, and the one or more criteria comprises: computing a block error rate, BLER, value for the second part of the SCI based on the one or more RLM measurements and the one or more hypothetical transmission parameters for the second part of the SCI; and comparing the BLER value to the one or more BLER thresholds.

Embodiment 19: The method of embodiment 17 or 18 wherein the RLM metric is in-sync or out-of-sync.

Embodiment 20: The method of any of embodiments 17 to 19 wherein the one or more criteria is a function of a priority of one or more services with different quality of service requirements involved with the sidelink between the first and second wireless communication devices.

Embodiment 21: The method of any of embodiments 17 to 20 wherein the one or more criteria is a function of a precoder used for transmission of the one or more reference signals.

Embodiment 22: The method of any of embodiments 17 to 21 wherein the one or more criteria is a function of a number of layers used for transmission of the second part of the SCI.

Embodiment 23: The method of any of embodiments 16 to 22 wherein the information regarding the one or more reference signals that are present on the sidelink for radio link monitoring measurements comprises information needed by the second wireless communication device to receive the one or more reference signals on the sidelink.

Embodiment 24: The method of any of embodiments 16 to 22 wherein the information regarding the one or more reference signals that are present on the sidelink for radio link monitoring measurements comprises information that implicitly or explicitly indicates a time, frequency, or code resource allocation for the one or more reference signals.

Embodiment 25: The method of embodiment 24 wherein the information that implicitly or explicitly indicates a time, frequency, or code resource allocation for the one or more reference signals comprises one or more bit fields that provide the time, frequency, and/or code resource allocation for the one or more reference signals.

Embodiment 26: The method of embodiment 24 wherein the information that implicitly or explicitly indicates a time, frequency, or code resource allocation for the one or more reference signals comprises a single bit that indicates the presence of the one or more reference signals on predefined or preconfigured time, frequency, and/or code resources.

Embodiment 27: The method of embodiment 24 wherein the information that implicitly or explicitly indicates a time, frequency, or code resource allocation for the one or more reference signals comprises a CRC that implicitly indicates the time, frequency, and/or code resources used for the one or more reference signals.

Embodiment 28: The method of any of embodiments 16 to 27 wherein the one or more reference signals comprise one or more DMRS.

Embodiment 29: The method of any of embodiments 16 to 27 wherein the one or more reference signals comprise two or more DMRS for two or more different physical channels.

Embodiment 30: The method of any of embodiments 16 to 29 wherein the one or more reference signals comprise one or more CSI-RS.

Embodiment 31: The method of any of embodiments 16 to 30 wherein the one or more reference signals comprise one or more PTRS.

Embodiment 32: The method of any of embodiments 16 to 31 wherein the one or more reference signals comprise two or more different types of reference signals.

Embodiment 33: The method of any of embodiments 16 to 32 further comprising sending (408) information that indicates a radio link failure to the first wireless communication device.

Embodiment 34: The method of any of embodiments 16 to 32 further comprising declaring (408) a radio link failure based on the determined RLM metric.

Embodiment 35: The method of embodiment 34 wherein the determined RLM metric is out-of-sync.

Embodiment 36: The method of embodiment 34 or 35 further comprising, upon declaring (408) the radio link failure, performing one or more actions comprising one or more of the following: signaling information that indicates the radio link failure to another node (e.g., the first wireless communication device); determining one or more hypothetical transmission parameters for the second part of the SCI to be used for future determination of a future RLM metric; determining a parameter to be used for transmission of the second part of the SCI or a physical sidelink control channel; or transmitting a control message that declares the radio link failure using a (e.g., determined) parameter (e.g., in the second part of the SCI or in the corresponding physical sidelink shred channel).

Embodiment 37: The method of any of embodiments 16 to 36 wherein the second part of the SCI shares DMRS with a physical data channel on the sidelink.

Embodiment 38: The method of any of embodiments 16 to 37 wherein the first part of the SCI is transmitted on a PSCCH that has a dedicated set of DMRS.

Embodiment 40: A wireless communication device comprising: processing circuitry configured to perform any of the steps of any of Embodiments 1-38; and power supply circuitry configured to supply power to the wireless communication device.

Embodiment 41: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of Embodiments 1-38; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

At least some of the following abbreviations may be used in this disclosure. If there is an inconsistency between abbreviations, preference should be given to how it is used above. If listed multiple times below, the first listing should be preferred over any subsequent listing(s).
5GC Fifth Generation Core
5GS Fifth Generation System
AF Application Function
AMF Access and Mobility Function
AN Access Network
AP Access Point
ASIC Application Specific Integrated Circuit
AUSF Authentication Server Function
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
P-GW Packet Data Network Gateway
QoS Quality of Service
RAM Random Access Memory
RAN Radio Access Network
ROM Read Only Memory
RRH Remote Radio Head
RTT Round Trip Time
SCEF Service Capability Exposure Function
SMF Session Management Function
UDM Unified Data Management
UE User Equipment
UPF User Plane Function

Those skilled in the art will recognize improvements and modifications to the embodiments of the present disclosure. All such improvements and modifications are considered within the scope of the concepts disclosed herein.

1. A method performed by a first wireless communication device for radio link monitoring for a sidelink between the first wireless communication device and a second wireless communication device, the method comprising:
transmitting a first part of sidelink control information, (SCI) to the second wireless communication device, the first part of the SCI comprising information regarding one or more reference signals that are present on the sidelink for radio link monitoring measurements.

2. The method of claim 1 further comprising:
transmitting a second part of the SCI to the second wireless communication device;
transmitting data on a physical sidelink shared channel; and
transmitting the one or more reference signals on the sidelink;
wherein the second part of the SCI comprises information related to decoding the data transmitted on the physical sidelink shared channel.

3. The method of claim 2 wherein the information related to decoding the data transmitted on the physical sidelink shared channel comprises:
a) information about a modulation a coding scheme used for the data transmitted on the physical sidelink shared channel,
b) a hybrid automatic repeat request, (HARQ) identity of a HARQ process associated to the data transmitted on the physical sidelink shared channel,
c) a redundancy version of the data transmitted on the physical sidelink shared channel, or
d) a combination of any two or more of (a)-(c).

4. The method of claim 2 wherein the second part of the SCI shares demodulation reference signals with a physical data channel on the sidelink.

5. The method of claim 2 further comprising:
receiving information that indicates a radio link failure from the second wireless communication device; and
performing a radio link failure recovery procedure in response to receiving the information that indicates a radio link failure from the second wireless communication device.

6. The method of claim 5 wherein performing the radio link recovery procedure comprises reconfiguring one or more transmission parameters for a second part of the SCI.

7. The method of claim 1 wherein the first part of the SCI is transmitted on a physical sidelink control channel that has a dedicated set of demodulation reference signals.

8. The method of claim 1 wherein the first part of the SCI further comprises resource allocation related information.

9. The method of claim 1 wherein the information regarding the one or more reference signals that are present on the sidelink for radio link monitoring measurements comprises information needed by the second wireless communication device to receive the one or more reference signals on the sidelink.

10. The method of claim 1 wherein the information regarding the one or more reference signals that are present on the sidelink for radio link monitoring measurements comprises information that implicitly or explicitly indicates a time, frequency, or code resource allocation for the one or more reference signals.

11. The method of claim 10 wherein the information that implicitly or explicitly indicates a time, frequency, or code resource allocation for the one or more reference signals comprises:
one or more bit fields that provide the time, frequency, and/or code resource allocation for the one or more reference signals,
a single bit that indicates the presence of the one or more reference signals on predefined or preconfigured time, frequency, and/or code resources, or
a cyclic redundancy check, CRC, (CRC) that implicitly indicates the time, frequency, and/or code resources used for the one or more reference signals.

12. The method of claim 1 wherein the one or more reference signals comprise:
one or more demodulation reference signals,
two or more demodulation reference signals for two or more different physical channels,
one or more channel state information reference signals, or
one or more phase tracking reference signals.

13. The method of claim 1 wherein the one or more reference signals comprise two or more different types of reference signals.

14-15. (canceled)

16. A first wireless communication device for radio link monitoring for a sidelink between the first wireless communication device and a second wireless communication device, the first wireless communication device comprising:
one or more transmitters;
one or more receivers; and
processing circuitry associated with the one or more transmitters and the one or more receivers, the processing circuitry configured to cause the first wireless communication device to:
transmit a first part of sidelink control information (SCI) to the second wireless communication device, the first part of the SCI comprising information regarding one or more reference signals that are present on the sidelink for radio link monitoring measurements.

17. A method performed by a second wireless communication device for radio link monitoring for a sidelink between a first wireless communication device and the second wireless communication device, the method comprising:
receiving a first part of sidelink control information (SCI) from the first wireless communication device, the first part of the SCI comprising information regarding one or more reference signals that are present on the sidelink for radio link monitoring measurements;
determining a presence of the one or more reference signals on the sidelink based on the first part of the SCI;
performing one or more radio link monitoring, RLM, (RLM) measurements on the one or more reference signals; and
determining a RLM metric based on the one or more RLM measurements.

18. The method of claim 17 wherein the first part of the SCI is transmitted on a physical sidelink control channel that has a dedicated set of demodulation reference signals.

19. The method of claim 17 wherein the first part of the SCI further comprises resource allocation related information.

20. The method of claim 17 wherein a second part of the SCI comprises information related to decoding data transmitted from the first wireless communication device to the second wireless communication device on a physical sidelink shared channel.

21-42. (canceled)
